(19) United States
(12) Patent Application Publication
(10) Pub. No.: US 2007/0047583 A1
(43) Pub. Date: Mar. 1, 2007

(54) Method for using a short address in a packet header

(75) Inventors: Eyal Assa, Hod Hasharon (IL); Dekel Shirizly, Pardes Hana (IL); David Berechya, Tel-Mond (IL); Alon Hazay, Tel Aviv (IL); Ilya Vershkov, Rishon LeZion (IL); Nissim Gerbi, Petach Tikva (IL)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/214,301

(22) Filed: Aug. 29, 2005

(51) Int. Cl. H04J 3/16

(52) U.S. Cl. 370/471

(57) ABSTRACT

A method and device for changing between a long address and a short address in a packet is provided. According to one embodiment, a method of converting a long address to a short address by an processing element in a communication network, comprises receiving a packet having a first long address, retrieving a first short address associated with the first long address from a data repository, replacing the first long address in the standard packet with the first short address forming an improved packet with a control field and sending the improved packet toward a subsequent device.

### FIELD OF THE INVENTION

The present invention relates to a method for using a short address in a packet, and more particularly, to a method in a communication network for using a short address in a packet to avoid bandwidth speedup.

### BACKGROUND

Packets having a header are sent between different elements of a communication network. The header may include information such as an address, protocol, security, Quality of Service (QoS), and the like. A network element may contain several processing elements. While performing a portion of the complete process each element typically increases the packet size when adding information to the packet. The increase packet size increases bandwidth, commonly referred to as “bandwidth speedup”. When bandwidth speedup occurs, higher bandwidth links between the processing elements are commonly used in the network elements to handle the increased bandwidth.

There exists a need to provide an improved packet processing in a communication network.

### SUMMARY OF THE INVENTION

An aspect of the present invention involves a method of converting a long address to a short address by a processing element in a communication network, comprising receiving a standard packet having a first long address, retrieving a first short address associated with the first long address from a data repository, and replacing the first long address in the standard packet with the first short address forming an improved packet with a control field.

Another aspect of the present invention involves a method of converting a short address to a long address by a processing element in a communication network, comprising receiving a packet having a short address, retrieving from a data repository a long address associated with the short address, replacing the short address in the improved packet with the long address forming a standard packet, and sending the standard packet toward a subsequent device.

Yet another aspect of the present invention involves a modified Ethernet switch that converts between a Media Access Control (MAC) address and short address, comprising a first processing element and a second processing element. The first processing element having access to a first data repository and receives a first standard packet having an Ethernet header. The Ethernet header having a first MAC destination address and a MAC source address. The first processor converting the first MAC destination address to a first short address. The first processor replacing the first MAC destination address in the standard packet with the first short address forming an improved packet. The second processing element having a second data repository and receives the improved packet. The second processor converting the short destination address to the first MAC destination address. The second processor replacing the short destination address in the improved packet with the first MAC destination address forming a second standard packet. Wherein the first short address uses less bits that the first MAC address.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the present invention. The drawings contain the following figures, in which like numbers refer to like parts throughout the description and drawings wherein:

FIG. 1 illustrates an exemplary prior art schematic diagram of a communication network;

FIG. 2 illustrates an exemplary prior art diagram of a packet used in a communication network;

FIG. 3 illustrates an embodiment of an exemplary diagram of a packet used in a communication network in accordance with the present invention;

FIG. 4 illustrates an exemplary schematic diagram of a communication network in accordance with the present invention;

FIG. 5 illustrates an exemplary flow diagram for replacing a long address with a short address in accordance with the present invention;

FIG. 6 illustrates an exemplary flow diagram for associating a long address with a short address in accordance with the present invention;

FIG. 7 illustrates an exemplary flow diagram for replacing a short address with a long address in accordance with the present invention; and

FIG. 8 illustrates an exemplary packet flow in accordance to the present invention.

### DETAILED DESCRIPTION OF THE INVENTION

The invention described herein may employ one or more of the following concepts. For example, one concept relates to avoiding bandwidth speedup. Another concept relates to modifying a packet to replace a long address with a short address to free up bits in the header. Another concept relates to modifying a packet to replace a short address with a long address. Yet another concept relates to a source for converting between a long address and a short address.

The present invention is disclosed in context of use of an Ethernet switch using Media Access Control (MAC) addresses. The principles of the present invention, however, are not limited to use with Ethernet switch but may be applied to other network elements having an Open Systems Interconnection (OSI) model layer-2 type other than Ethernet, such as High-Level Data Link Control (HDLC). Also, address schemes, presently known or later developed, other than MAC addresses may also be used. Furthermore, the principles of the present invention are not limited to the network element using the OSI layer-2 models or data-link layer addresses but may be applied to any communication network models and addresses presently known or later developed. While the present invention is disclosed in terms of converting a destination address in a packet to a short address the principles of the present invention are not limited to converting the destination address but may be applied to any address in a packet.

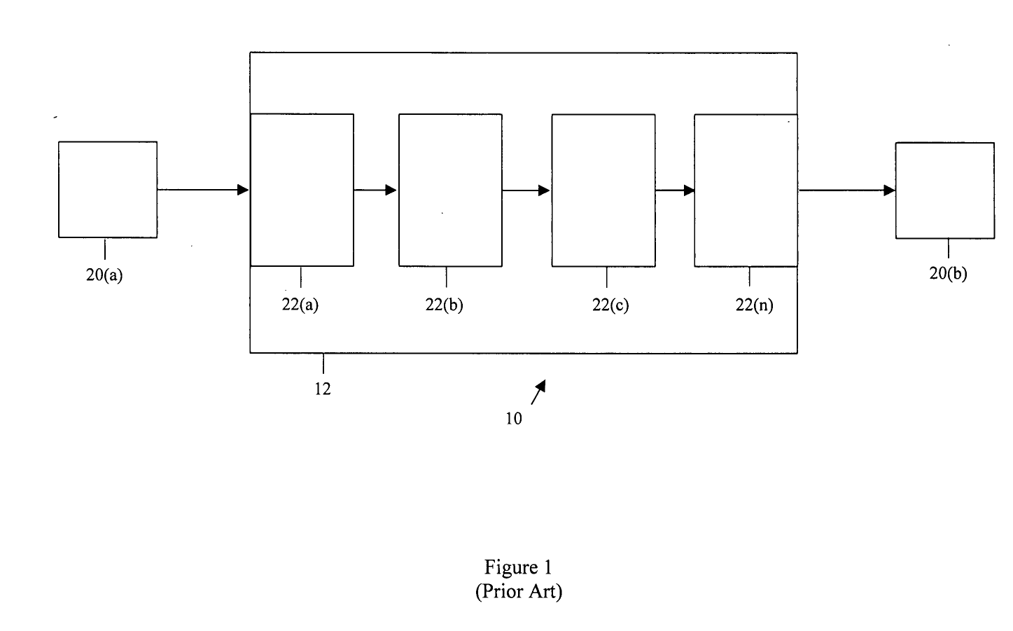

Referring to FIG. 1, an exemplary prior art schematic diagram of a communication network 10 is shown. The illustrated communication network 10 includes a traffic source 20(a), an Ethernet switch 12, and a traffic destination 20(b). The traffic source 20(a) and the traffic destination 20(b) are coupled to the Ethernet switch 12. Throughout this document, the term “coupled” refer to any direct or indirect communication between two or more entities in communication network 10, whether or not those entities are in physical contact with one another. Traffic flows between the traffic source 20(a) and the traffic destination 20(b) via the Ethernet switch 12. “Traffic” refers to a packet, a message, streams of packets or messages, or other suitable form(s) of data, voice or combinations thereof.

The Ethernet switch 12 includes hardware, or a combination of hardware and software to perform processing such as switching, routing, security, and Quality of Service (QoS). The Ethernet switch 12 has processing elements 22(a through n) that include processors, Application-Specific Integrated Circuit (ASIC) devices or other devices capable of performing processing such as forwarding, flow classification, traffic policing, QoS. As traffic flows through the Ethernet switch 12, the processing element 22 may increase the packet size while adding information in the packet, thereby causing a bandwidth speedup. Bandwidth speedup is a problem since a processing element 22 may not be able to cope with the incoming traffic rate causing degradation to a traffic throughput.

For this example, traffic flows from traffic source 20(a) to processing element 22(a), then to processing element 22(b), to processing element 22(c), to processing element 22(n), to traffic destination 20(b). In this example, processing element 22(a) is the ingress-processing element and processing element 22(n) is the egress-processing element.

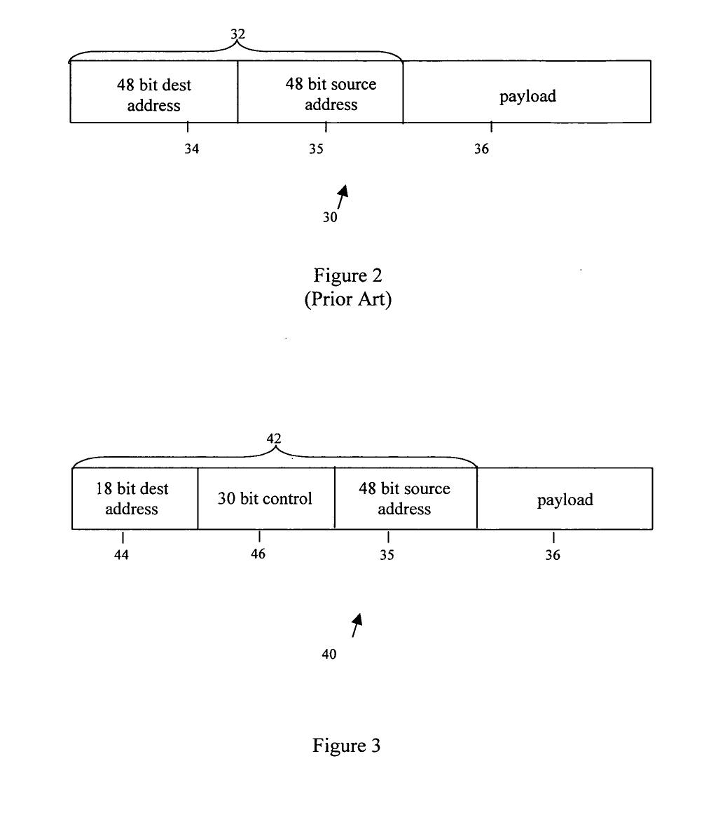

Now referring to FIG. 2, an exemplary prior art Ethernet packet 30, hereinafter referred to as a standard packet 30 is shown. The standard packet 30 includes a header 32 and a payload 36. The header 32 includes a long address for a destination address 34 (hereinafter referred to as a long destination address 34) and the long address for a source address 35 (hereinafter referred to as a long source address 35). The “long address” may be any address to refer to a device or a connection, e.g. a physical address, a virtual address. In this example the long address refers to a 48-bit MAC address providing 256 terabytes of addresses. The payload 36 includes the information to be delivered in the communication network 10, such as data, voice, or combinations thereof.

Now referring to FIGS. 1, 2 and 3, an exemplary packet 40 in accordance to the present invention, hereinafter referred to as an improved packet 40, is shown. The improved packet 40 includes a header 42 and a payload 36. The illustrated improved packet 40 includes a destination address 44 represented as the long address (hereinafter referred to as short destination address 44), a source address 35 represented as a long address, and a control field 46. The short address is an address using a number of bits that is less than the number of bits in the long address. Preferably the short address is based on a power of 2 due to the binomial nature of bits. The maximum number of short address may be based on the number of MAC addresses supported in the Ethernet switch 12 via the maximum number of MAC entries in a MAC table also commonly referred to as a forwarding database. The maximum number of short address is less than a maximum combination of MAC addresses. For example, the maximum number of short address is less than 2⁴⁸. Additionally, it may be possible for the maximum number of short addresses to be configurable.

FIG. 3 illustrates how a packet having a plurality of addresses may have one or more address(es) represented as the long address and one or more address(es) represented as the short address. Additionally, all the addresses may be represented as the short address. Therefore it would be appreciated by those skilled in the art that long source address 35 could be represented as the short address instead of the long address. Also, it would be appreciated that the short destination address 44 could remain as a long address while the long source address 35 was represented as the short address.

In the illustrated example of FIG. 3, the short address is based on 18 bits providing 256 Kilobyte addresses thus providing 30-bit control field 46 that may be used to represent control data for packet processing. Therefore, the improved packet 40 allows processing elements to include information without adding to the size of the improved packet 40.

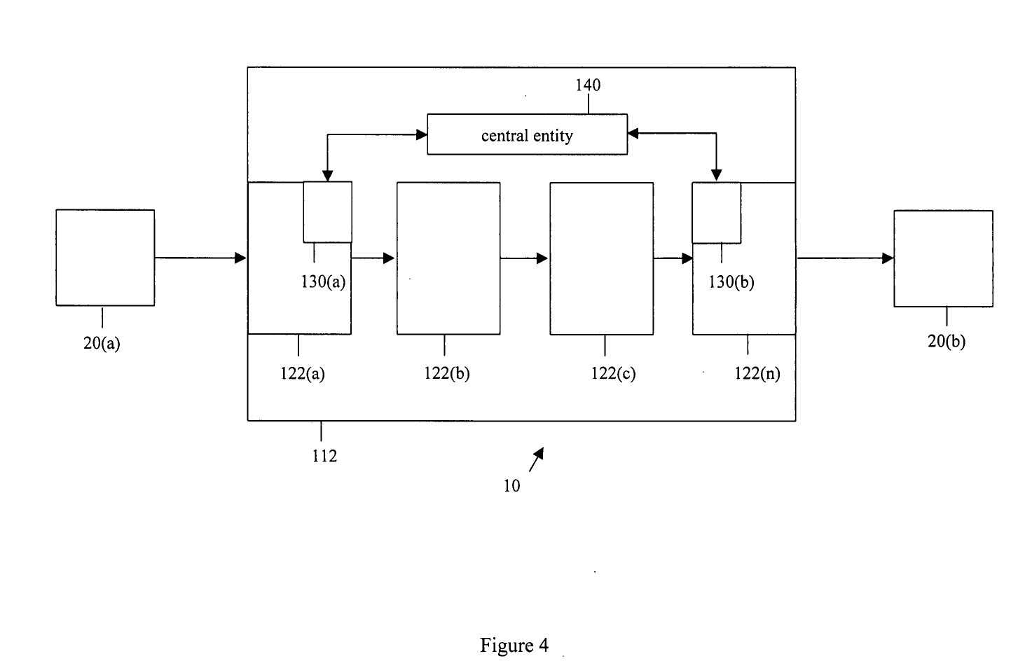

Now referring to FIGS. 2, 3, and 4, an exemplary flow diagram of a communication network in accordance with the present invention is shown. The illustrated communication network 10 includes the traffic source 20(a) and the traffic destination 20(b) and a modified Ethernet switch 112. The traffic source 20(a) and the traffic destination 20(b) are coupled to the modified Ethernet switch 112. The modified Ethernet switch 112 includes hardware, or a combination of hardware and software to perform processing such as routing, security, QoS, flow classification, traffic policing and the like. The modified Ethernet switch 112 has processing elements 122(a through n) that include processors, ASIC devices or other devices capable of performing processing. Although FIG. 4 illustrates 4 processing elements 122, it would be appreciated by those skilled in the art that there may be more or less elements 122 in the modified Ethernet switch 112. The modified Ethernet switch 112 includes a central entity 140 that controls updating a data repository 130 data repository that may be included in the processing element 122. The data repository 130 is preferable a data table. However, it may be a database or any suitable data structure, method or device to save and retrieve data. Traffic flows between the traffic source 20(a) and the traffic destination 20(b) via the modified Ethernet switch 112. For this example, traffic flows from the traffic source 20(a) to processing element 122(a), then to processing element 122(b), to processing element 122(c), to processing element 122(n), to traffic destination 20(b). In this example, processing element 122(a) is the ingress-processing element and processing element 122(n) is the egress-processing element. The processing element 122 or traffic destination 20(b) that is receiving the traffic is considered the subsequent device. The processing element 122 or traffic source 122(a) that sends the traffic is considered the previous device.

To make use of the benefits of the short destination address 44, when a processing element 122 receives a standard packet 30, the processing element 122 replaces the long destination address 34 with the short destination address 44 to form an improved packet 40. It is preferable the replacement is done in the ingress-processing element 122(a) since it is the first element. However, the replacement may be done by a processing element 122 other than the ingress-processing element 122(a). The packet is sent toward a subsequent device 122. “Toward” refers to sending the packet from a sending point to a receiving point either directly or indirectly and wherein the sending point does not have to originate the packet and wherein the packet does not have to end at the receiving point

Prior to the traffic leaving the modified Ethernet switch 112, the processing element 122 replaces the short destination address 44 in the improved packet 40 with a long destination address 34 to form a standard packet 30. It is preferable that this replacement is done in the egress-processing element 122(n) since it is the last processing element 122 so that the use improved packet 40 made as long a possible. However, the replacement may be done by a processing element 122 other than the egress-processing element 122(n).

An example of packet processing using according to the present invention is as follows. A standard packet 30 is received by the ingress-processing element 122(a), the ingress-processing element 122(a) forms an improved packet 40 as described above, modifies the control field 46 in the improved packet 40, and sends the improved packet 40 to a subsequent element, processing element 122(b). Processing element 122(b) uses the information in the control field 46 provided by processing element 122(a), updates the control field 46, and sends the improved packet 40 to a subsequent element, processing element 122(c). Processing element 122(c) uses the information in the control field 46 provided by 122(a) and 122(b), and sends the improved packet 40 to a subsequent element, processing element 122(n). Processing element 122(n) uses the information in the control field 46 provided by 122(a) and 122(b), forms a standard packet 30 as described above, and sends the standard packet 30 to the traffic destination 20(b).

Not all of the processing elements 122(a through n) need to include the data repository 130. For example, processing elements 122 that do not replace the address do not need to include the data repository 130. However, any element that replaces a long address with the short address or vice versa preferably includes the data repository. If the data repository 130 is not included in a processing element 122(a), 122(n) that replaces the address, e.g. the data repository 130 is centralized or located in a different element, then the processing element 122(a), 122(n) should have access to the data repository 130.

An association between the short address and long address is maintained in the data repository 130. A central entity 140 is responsible for updating and synchronizing the tables 130 when a new association is made or removed For example, if a new association is made in data repository 130(a), the central entity 140 is responsible for updating data repository 130(b).

When the processing element 122(a) receives a standard packet 30, the data repository 130 is searched for the long destination address 34 to find an associated short address. The long destination address 34 is replaced with the associated short address forming an improved packet 40 with a short destination address 44. As recognized by those skilled in the art that there are many search methods, such as hash tables. If there is an association for the destination long address 34 the associated short address is used. However, if there is no associated short address, e.g. the long destination address 34 does not exist in the data repository 130, and then the packet is sent without modification to the long destination address 34, which may cause a temporary congestion of a traffic flow.

Additionally, when the processing element 122(a) receives a standard packet 30, a new association of the long source address 35 with a short address may be made in the data repository if the association does not already exist. The new association is made by finding a spare short address and updating the data repository to have the long source address 35 with the associated short address. As recognized by those skilled in the art that there are many way to find spare information. For example, a bit map indicating spare short addresses, or a link list of free short addresses.

It is also possible to remove an association through a process called aging. Aging involves removing an association after a period of time, whereupon the association is deemed “old”. The time period that an association becomes old may be configurable. Preferably the time period is greater than the time it takes for the modified Ethernet switch 112 to process the packet; otherwise, the association would not be there to replace the short address with the long address. More preferably, the time period is long enough to allow subsequent packet having the same long address use the association. When a subsequent packet having the same long address is received it is desirable to reset the time period for the association to keep it alive.

One skilled in the art would appreciate a packet may having more or less addresses than illustrated in FIG. 4.

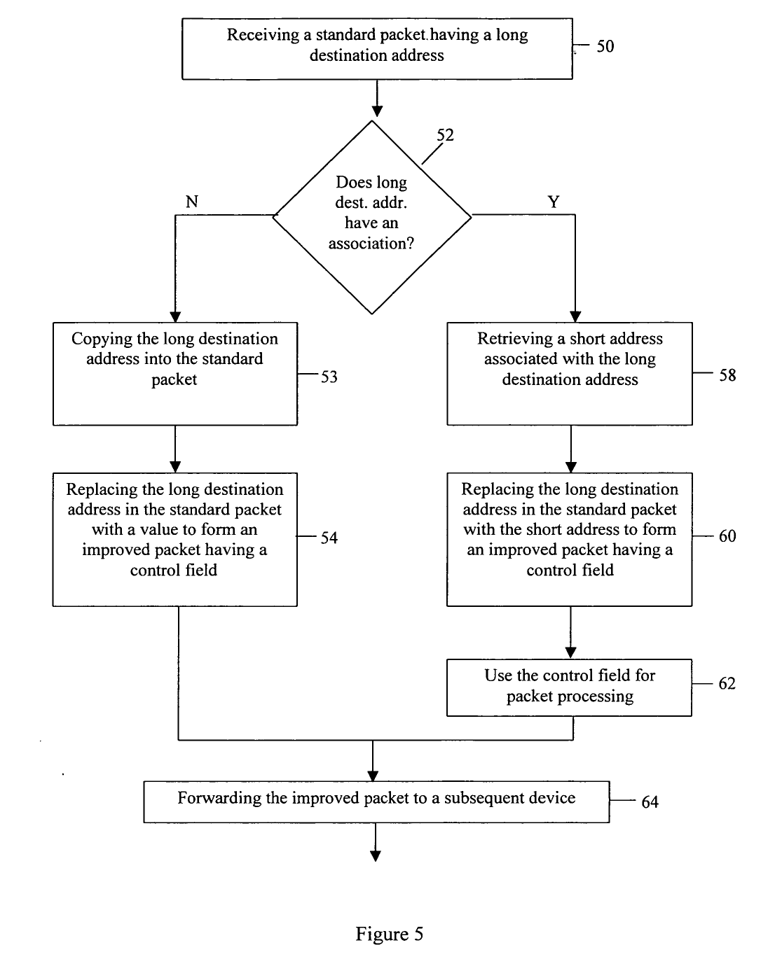

Now referring to FIG. 5, an exemplary flow of converting the long address to the short address is shown. After receiving a standard packet 50 having a long destination address, a check is made to see if the long destination address has an associated short address is stored in a data repository 52.

If the long destination address has an associated short address stored in the data repository the associated short address is retrieved from the data repository 58. The long destination address is replaced by the associated short address forming and improved packet having a control field 60, wherein the control field may be used for packet processing 62. The improved packet is forwarded to a subsequent device 64.

If, however, the long address is not stored in the data repository the long destination address is copied into the standard packet 53, preferably after the packet header. The long destination address is replaced with a value that may be ascertained by the processing elements forming an improved packet having a control field 54. The “value” is to indicate to subsequent devices that an association was not found. The value may be predefined, provided in the data repository or any other suitable way that allows the processing elements to have access to the value. Additionally, the value should be selected to not conflict with a short address, e.g. they should be mutually exclusive. The packet is sent without modification to the long destination address 54, which may cause a temporary congestion of a traffic flow due to the increased packet size.

The improved packet is forwarded to a subsequent device 64.

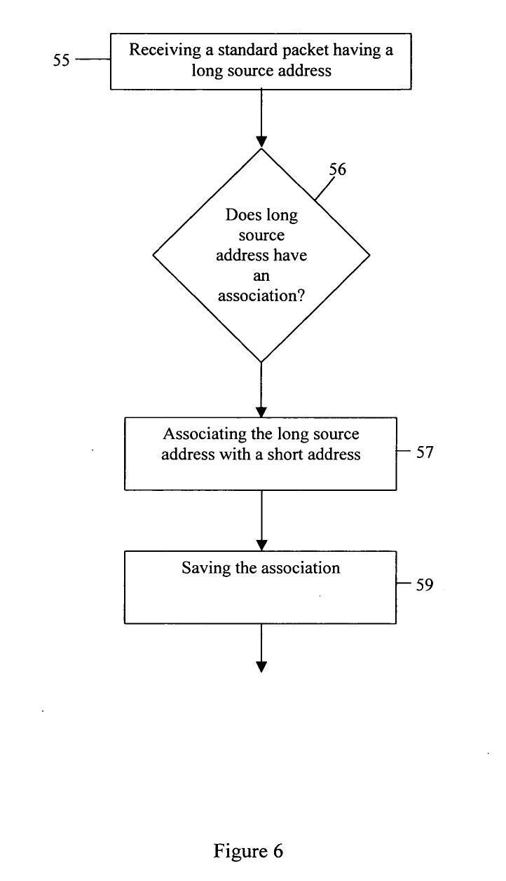

Now referring to FIG. 6, an exemplary flow of associating a long address with the short address is shown. After receiving a standard packet 55 having a long source address, a check is made to see if the long source address has an associated short address is stored in a data repository 56. If the long destination address does not have an associated short address an association is created 56 and saved in the data repository 57.

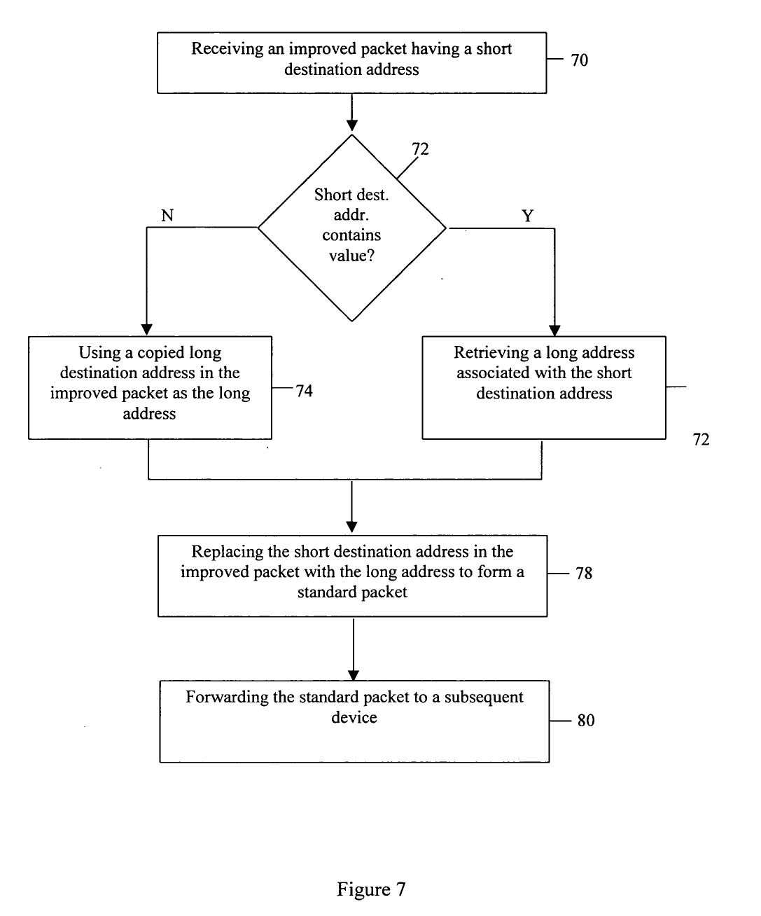

Now referring to FIG. 7, an exemplary flow of converting the short address to the long address is shown. After receiving an improved packet having a short destination address from a previous device 70, a check is made to see if the short destination address contains the value as previously described 72.

If the short destination address contains the value, the long address is set the copied long destination address in the improved header 74.

If the short destination address does not contain the value, the long address associated with the short destination address is retrieved from a data repository 72.

The short destination address is replaced in the improved packet with the long address thereby forming a standard packet having a long destination address 78. The standard packet is forwarded to the subsequent device 80.

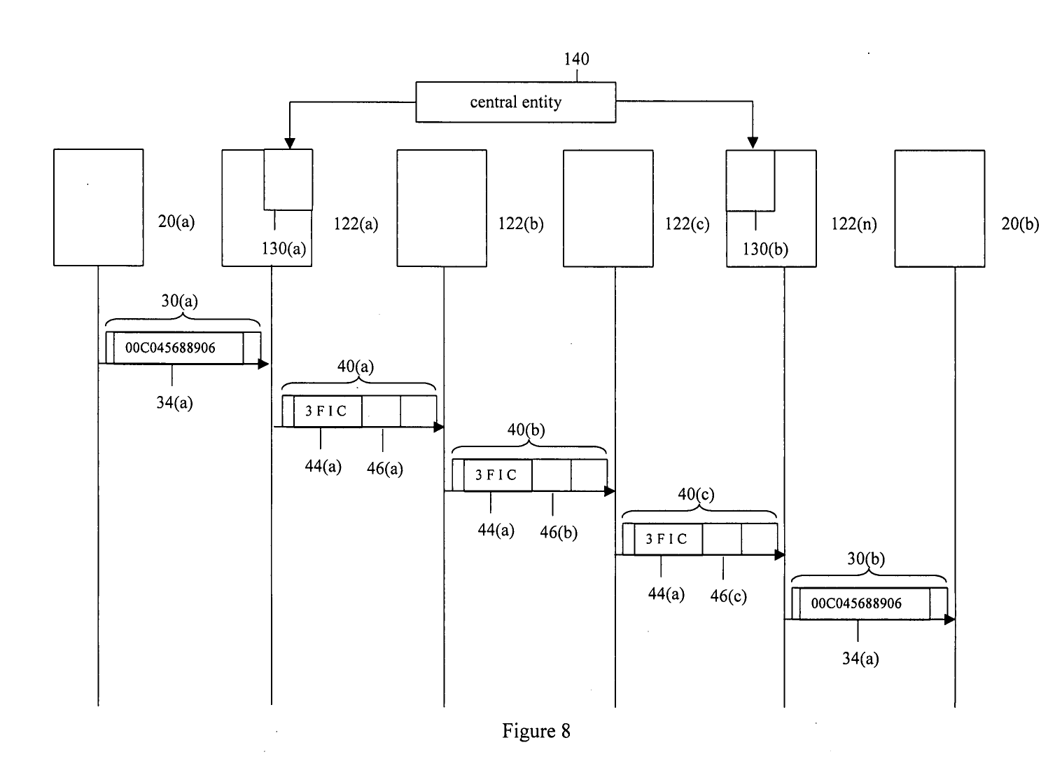

Referring now to FIG. 8, an exemplary message flow in accordance to the present invention is shown. The traffic source 20(a) sends a standard packet 30(a) to the processing element 122(a). The standard packet 30(a) having a long destination address 34(a) of 00 C0 45 68 89 06 (hexadecimal).

The processing element 122(a) receives the standard packet 30(a) and retrieves a short address association with the long destination address 34(a). The processing element 122(a) replaces the long destination address 34(a) with a short address forming an improved packet 40(a) with a short destination address 44(a). Additionally, the processing element 122(a) updates the control field 46(a) to have indications such as the destination port, traffic class, drop precedence, flow number, and the like, and sends the improved packet 40(a) to processing element 122(b).

Processing element 122(b) receives the improved packet 40(a) and processes information in the control field 46(a). The control field is updated to have the processing results of the processing element 122(b) and the updated packet 40(b) is sent toward processing element 122(c).

Processing element 122(c) receives the improved packet 40(b) and processes information in the control field 46(b). The control field is updated to have the processing results of the processing element 122(c) and the updated packet 40(c) is sent toward processing element 122(n).

Processing element 122(n) receives the improved packet 40(c) and retrieves the long address associated with the short destination address 44(a). The processing element 122(n) replaces the short destination address 44(a) with the associated long address to form a standard packet 30(b) having a long destination address 34(a). The standard packet 30(d) is sent toward the traffic destination 20(b).

The present invention may be embodied in many different forms and may be applied to many different types of networks, and addresses and should not be construed as limited to the embodiments set forth herein. Rather, these embodiments are provided so that this disclosure will be thorough and complete, and will fully convey the scope of the present invention to those skilled in the art. Thus, the scope of the present invention should be determined based upon the appended claims and their legal equivalents, rather than the specific embodiments described above.

1. A method of converting a long address to a short address by a processing element in a communication network, comprising:
receiving a standard packet having a first long address;
retrieving a first short address associated with the first long address from a data repository; and
replacing the first long address in the standard packet with the first short address forming an improved packet with a control field.

2. The method as claimed in claim 1, wherein the standard packet has a second long address, the method further comprising:
associating the second long address with a second short address, and
storing the association in the data repository.

3. The method as claimed in claim 2, wherein the first and second long addresses are the same field in the packet.

4. The method as claimed in claim 1, wherein if an association does not exist for the first long address:
skipping the retrieving and replacing,
copying the first long address to the standard packet, and
replacing the first long address in the standard packet with a value to form an improved packet.

5. The method as claimed in claim 1, wherein short address is an address using a number of bits that is less than the number of bits in the long address.

6. The method as claimed in claim 5, wherein the association in the data repository between the short address and long address is aged.

7. The method as claimed in claim 1, wherein the long address is a Media Access Controller (MAC) address.

8. A method of converting a short address to a long address by a processing element in a communication network, comprising:
receiving a packet having a short address;
retrieving from a data repository a first long address associated with the short address from a data repository; and
replacing the short address in the improved packet with the long address forming a standard packet.

9. The method as claimed in claim 8, wherein if the short address contains a value
skipping the retrieving, and
wherein the long address is a second long address from improved packet

10. The method as claimed in claim 8, wherein the data repository is capable of storing a maximum number of short addresses and wherein the maximum number of short addresses is less than a maximum number of long addresses.

11. The method as claimed in claim 9, wherein the maximum number of short address is based on a power of 2.

12. The method as claimed in claim 11, wherein the association in the data repository between the short address and long address is aged.

13. The method as claimed in claim 8, wherein the long address is a Media Access Controller (MAC) address.

14. A modified Ethernet switch that converts between a Media Access Control (MAC) address and short address, comprising:
a first processing element having access to a first data repository and receives a first standard packet having an Ethernet header, the Ethernet header having a first MAC destination address and a MAC source address, the first processor converting the first MAC destination address to a first short address, the first processor replacing the first MAC destination address in the standard packet with the first short address forming an improved packet; and
a second processing element having a second data repository and receives the improved packet, the second processor converting the short destination address to the first MAC destination address; the second processor replacing the short destination address in the improved packet with the first MAC destination address forming a second standard packet,
wherein the first short address uses less bits that the first MAC address.

15. The modified Ethernet switch as claimed in claim 14, wherein the converting the first MAC destination address to a first short address, comprising:
retrieving from the first source an address associated with the first MAC destination address, the first short address is the associated address or
copying the first MAC destination address to a second MAC destination address in the improved packet, the first short address is a value.

16. The modified Ethernet switch as claimed in claim 15, wherein the converting the short destination address to a MAC destination address, comprising:
retrieving from the second source an address associated with the short destination address, the short destination address is the associated address or
retrieving from the improved packet the second MAC address, the short destination address is the second MAC

17. The modified Ethernet switch as claimed in claim 14, wherein the first and second sources are the same.

18. The modified Ethernet switch as claimed in claim 14, further comprising sending the second standard packet toward a traffic destination.

19. The modified Ethernet switch as claimed in claim 14, further comprising the first processing element storing an association between the MAC source address and a second short address in the first data repository.

20. The modified Ethernet switch as claimed in claim 14, wherein the association is aged.

21. The modified Ethernet switch as claimed in claim 14, wherein access to the first data repository or the second data repository is via a central entity, the central entity synchronizes the first and second data repository.

22. The modified Ethernet switch as claimed in claim 14, wherein the first processing element converts the MAC destination address to a first short address via the first data repository.

23. The modified Ethernet switch as claimed in claim 14, wherein the second processing element converts the short destination address to a MAC via the second data repository.
